(19) United States
(12) Patent Application Publication
(10) Pub. No.: US 2023/0326009 A1
(43) Pub. Date: Oct. 12, 2023

(54) ERROR CORRECTION IN DENDRITIC PATTERNS

(71) Applicant: Michael N. Kozicki, Phoenix, AZ (US)

(72) Inventor: Michael N. Kozicki, Phoenix, AZ (US)

(21) Appl. No.: 18/133,885

(22) Filed: Apr. 12, 2023

Related U.S. Application Data
(60) Provisional application No. 63/330,215, filed on Apr. 12, 2022.

(51) Int. Cl. G06T 7/00; G06V 20/80

(52) U.S. Cl. CPC G06T 7/0006; G06V 20/80

(57) ABSTRACT

Assessing corruption of a dendritic structure includes obtaining an image of a dendritic structure having a plurality of branches extending away from a common point of the dendritic structure and defining a stochastic arrangement of branches, and assessing, based on the image, whether an arrangement of one or more of the branches violates a formation role governing formation of the dendritic structure.

### CROSS-REFERENCE TO RELATED APPLICATION

This application claims the benefit of U.S. Application No. 63/330,215 entitled “ERROR CORRECTION IN DENDRITIC PATTERNS” and filed on Apr. 12, 2022, which is incorporated by reference herein in its entirety.

### TECHNICAL FIELD

This invention relates to error identification and correction in dendritic patterns.

### BACKGROUND

Dendrites have been used as anti-counterfeiting, anti-tampering, and secure track-and-trace elements. Not only are they unique in every instance of formation and therefore may act as artificial fingerprints for items to which they are attached, but they also have attributes, including a unique micro- to nano-scale topography and optical features, which make their exact replication difficult. Their geometric character is also unusual—a consequence of formation processes that have both stochastic and role-based aspects which result in the formation of random minutiae in an otherwise recognizable overall structure.

### SUMMARY

This disclosure generally relates to methods of error identification and correction in synthetic (e.g., fabricated or non-biological) dendritic patterns. The structural predictability of dendritic patterns can be used in in error correction methods. The identified errors may be a result of scratches and contamination on the dendritic pattern (physical “noise”) or may be generated by reading distortion. They may also arise by the attempted removal or deliberate alteration of the pattern by malevolent forces.

In a general aspect, assessing corruption of a dendritic structure includes obtaining an image of the dendritic structure, and assessing, based on the image, whether the arrangement of one or more of the branches violates a formation rule governing formation of the dendritic structure. The dendritic structure includes branches extending away from a common point of the dendritic structure and defines a stochastic arrangement of the branches.

Implementations of the general aspect can include one or more of the following features.

Some implementations include identifying the dendritic structure as corrupted if the arrangement of the one or more of the branches violates the formation rule governing formation of the dendritic structure. Some implementations include identifying the dendritic structure as uncorrupted if the arrangement of the one or more branches obeys the formation rule governing formation of the dendritic structure. The formation rule is typically associated with a number of the branches, a spacing of the branches, a length of the branches, an angle between branches, or any combination thereof. In some cases, the formation rule is a power law rule associated with the number of the branches. The power law rule governs a number of branching points in each k^{th} order, wherein each k^{th} order has n^{k} branches, where n is an integer. In some cases, a region of the dendritic structure includes one or more self-similar features, and the formation rule is associated with a fractal dimension the region. In certain cases, one of the one or more self-similar features is a Y-shaped bifurcation comprising two of the branches extending from a trunk, and a length of the trunk and of each of the two branches is within ±30% of one-half of a total length of the dendritic structure. The fractal dimension can be log x/log y, wherein x is the number of branches in each region and y is a scaling factor of a length of the branches.

In some cases, the formation rule is associated with the presence or absence of crossings of the one or more of the branches with another branch. The presence of a crossing of one or more of the branches with another branch is typically indicative of a corrupted dendritic structure. In some cases, the formation rule is associated with the presence or absence of a discontinuity in the one or more of the branches. The presence of a discontinuity in the one or more of the branches can be indicative of a corrupted dendrite structure. In certain cases, one of the one or more branches is a re-entrant branch, and the presence of the re-entrant branch is indicative of a corrupted dendritic structure.

Some implementations include, after identifying the dendritic structure as corrupted, modifying the image to yield a modified image, wherein the arrangement of the one or more of the branches in the modified image conforms to the formation rule. Modifying the image can include interpolating between a discontinuity in a feature of the dendritic structure or extrapolating from a feature of the dendritic structure. In some cases, modifying the image includes removing a feature from the image, modifying one or more pixels in the image, or both. In certain cases, the formation rule is associated with a symmetry of the dendritic structure. In one example, a lack of reflection or rotation symmetry of the dendritic structure is indicative of a corrupted dendritic structure.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A-1C illustrate concept of fractal dimension using a line, a square, and a cube, respectively.

FIGS. 2A-2C depict Vicsek fractals with k=1, 2, and 3, respectively. FIGS. 2D-2F depict Mandelbrot-Vicsek deterministic fractal trees with k=1, 2, and 3, respectively.

FIG. 3A is an image of a dendrite formed by electrochemical deposition. FIGS. 3B-3F are images of the dendrite shown in FIG. 3A superimposed with a Y-shaped self-similar element repeated with k=1, 2, 3, 4, and 5 respectively.

FIG. 4A depicts a pristine dendrite. FIG. 4B depicts a damaged dendrite. FIG. 4C depicts a damaged dendrite with the damage identified.

FIG. 5A is a plot of quaternary capacity (Iₖ) versus magnification factor (M) for 3 values of D. The dashed line indicates the number of atoms on earth. FIG. 5B is an image of a radial dendrite with branching points circled.

### DETAILED DESCRIPTION

This disclosure describes methods of error identification in synthetic (e.g., fabricated or non-biological) dendritic patterns. As described herein, a dendritic pattern (also referred to as a dendritic structure or a dendrite) is a pattern that develops with a multi-branching, tree-like form that is generally defined as a rough or fragmented geometric shape that can be subdivided into parts, each of which is (at least superficially) a reduced-size copy of the whole, a property called self-similarity. This self-similarity leads to a fine structure at arbitrarily small scales. Because they appear similar (but not identical) at all levels of magnification, these fractals are often considered to be infinitely complex. In practice, however, the finest observable levels of structure can be limited by physical or chemical constraints.

The specific rules that dictate the formation of dendrites typically depend at least in part on the formation process. However, several rules are common to formation methods within a particular broad class (e.g., formation of dendrites by electrochemical means, fluid interactions, or other Laplacian instabilities in material systems). These rules can be related to branch spacing, branch length, branch angles, branch crossings, number of branches, and other physical features. Examples of various rules are provided below.

As described herein, dendritic patterns are generally symmetric, at least superficially, in that they appear substantially or structurally the same in reflection through a midline (e.g., for a tree-like dendrite, drawn from a top of the tree to the base of its trunk). A radial dendrite typically has radial or rotational symmetry (e.g., four-fold, five-fold, or six-fold symmetry).

In some dendritic patterns, a dendrite has constant branching governed by a power law that sets branch spacing, branch length, and numbers of branches at various levels of the structure (trunk, major branches, subordinate branches, minor branches, twigs, leaves/terminations). For some dendrites (e.g., radial dendrites), a number of branching points in each k^{th} order can be represented as n^{k} branches, where n is an integer. In one example of a radial dendrite where n=5, the number of branching points in each k^{th} order is given by 5^{k}, so that there are 5¹=5 trunks, 5²=25 major branches, 5³=125 subordinate branches, etc.

In some dendritic patterns, this power law dependence leads to self-similarity which keeps the fractal dimension constant for multiple generations of the fractal. In one example, if the self-similar/scale-invariant element that forms the dendritic structure is a Y-shaped bifurcation with roughly equal length segments and a range of angles between the arms, the number of line segments in each element is 3 and the scaling factor is 2 (since each line segment is approximately half the total length of the element), so the fractal dimension is log 3/log 2 for all generations.

In some dendritic patterns, branches emerge from trunks at a limited range of angles (e.g., 70 to 90 degrees), with no re-entrant branches (e.g., branches are not backward growing or do not extend toward an origin of the pattern, but rather toward a periphery of the pattern). In most dendritic patterns, branches are continuous and do not cross (e.g., do not extend through one another), so there are no breaks or closed features in the pattern.

Each dendritic pattern is recognizable by the set of formation rules which dictate its formation. These and other characteristics of dendritic patterns can form the basis for error detection schemes, in that pattern alteration (e.g., from an “uncorrupted” dendrite to a “corrupted” dendrite) can be recognized as a deviation from the rule-based multi-scale branching arrangement. In one example, all information units in a dendritic structure have the same fractal dimension and the same general shape, even if they differ in other ways. This rule-based predictability of general form provides an advantage when dendrites are used as identifiers, in that errors in the pattern can be identified when global or local rules have been violated, and can have utility in error correction. Dendrites do not require extensive extrinsic error correction due at least in part to their intrinsic predictability, which facilitates assessment of whether they have been corrupted as well as correction of an image of a corrupted dendrite. That is, if the form of the shape is known, missing portions can be added or extraneous objects can be removed based on the formation rules.

Accordingly, with knowledge of bow a dendritic structure should appear generally, corrupted features can be identified and corrected. Other errors, such as point defects in the pattern or in the spaces between the features, can be corrected using averaging techniques on a pixel level. In one example, if most of the pattern surrounding a “white” point is “black”, then the white point can be replace with a black point. In some approaches, a fractal dimension can be determined and monitored via a box-counting (or related) method to ensure integrity for the entire pattern or in specific regions. The identification of specific errors can be achieved by the use of adjacency algorithms that process data at the pixel level. In such methods, for any pixel that includes the pattern, there will exist a number of “allowed” adjacent pixels which arise from the pattern's fractal dimension and the formation rules of dendritic structure.

Assessing corruption of a dendritic structure can include obtaining an image of the dendritic structure, wherein the dendritic structure includes branches extending away from a common point of the dendritic structure and defines a stochastic arrangement of the branches, and assessing, based on the image, whether the arrangement of the branches violates a formation rule governing a corresponding uncorrupted dendritic structure. As used herein. “image” generally refers to a representation of a dendritic structure, and includes a stored electronic version of the image or dendritic structure. The dendritic structure can be identified as corrupted if the stochastic arrangement of branches violates the formation rule governing formation of the dendritic structure, and can be identified as uncorrupted if the stochastic arrangement of branches obeys the formation rule governing formation of the dendritic structure.

A formation rule can be associated with a number of the branches, a spacing of the branches, a length of the branches, or an angle between branches of the dendritic structure. In some cases, the formation rule is a power law rule associated with the number of the branches. In one example, the power law rule governs a number of branching points in each k^{th} order, wherein each k^{th} order has n^{k} branches, where n is an integer.

A formation rule can be associated with a fractal dimension of a self-similar feature of the dendritic structure. In one example, the self-similar feature is a Y-shaped bifurcation including two branches extending from a trunk, and a length of the trunk and of each branch is within ±30% of one-half of a total length of the dendritic structure. The fractal dimension can be log x/log y, where x is the number of branches in each element and y is a scaling factor of a length of the branches.

A formation rule can be associated with the presence or absence of crossings of the branches. In one example, the presence of a crossing of two of the branches is indicative of a corrupted dendritic structure. A formation rule can be associated with the presence or absence of discontinuities in the branches. In one example, the presence of a branch discontinuity is indicative of a corrupted dendritic structure. In some examples, the presence of a re-entrant branch is indicative of a corrupted dendritic structure.

After identifying a dendritic structure as corrupted, the image can be modified to yield a modified image, wherein the stochastically branched arrangement of the branches in the modified image conforms to the formation role. Modifying the image can include interpolating between a discontinuity in a feature of the dendritic structure or extrapolating from a feature of the dendritic structure, removing a feature from the image, or both. In some examples, modifying the image includes modifying one or more pixels in the image.

Dendrites described herein can be formed and imaged in a variety of methods, including electrochemical methods, multi-fluid methods, and other methods, such as those described in U.S. Pat. Nos. 9,773,141; 10,074,000; 10,810,731; and 11,430,233; U.S. Patent Publication Nos. 2021/0157888 and 2022/0027620; and PCT Publication Nos. 2022/032199; 2022/056300; and WO 2022/076934, all of which are incorporated by reference herein.

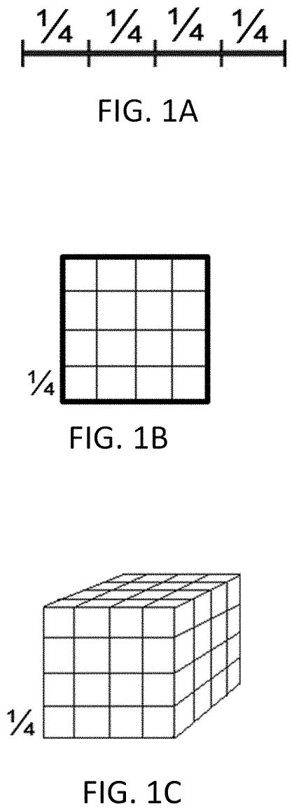

FIGS. 1A-1C illustrate the concept of “fractal dimension.” The line segment in FIG. 1A is divided into 4 smaller line segments. Each of the 4 line segments is similar to the original undivided line, but all line segments are ¼ the scale of the original undivided line. This example illustrates the concept of “self-similarity.” The square depicted in FIG. 1B is divided into 16 self-similar squares, each of which is ¼ the size of the original square in each dimension. The cube depicted in FIG. 1C is divided into 64 smaller cubes, each of which is ¼ the size of the original cube in each dimension. This example leads to Eq. 1:

N=S^{D} (1)

in which N is the number of self-similar small pieces that make up the larger piece, Sis the scale to which the larger piece compares to the smaller one, and D is the dimension—1, 2, or 3. For the line depicted in FIG. 1A, Eq. 1 gives 4=4¹. The square in FIG. 1B gives 16=4², and the cube in FIG. 1C gives 64=4³. Rearranging Eq. 1 gives Eq. 2:

D=log N/log S (2)

in which D is the fractal dimension.

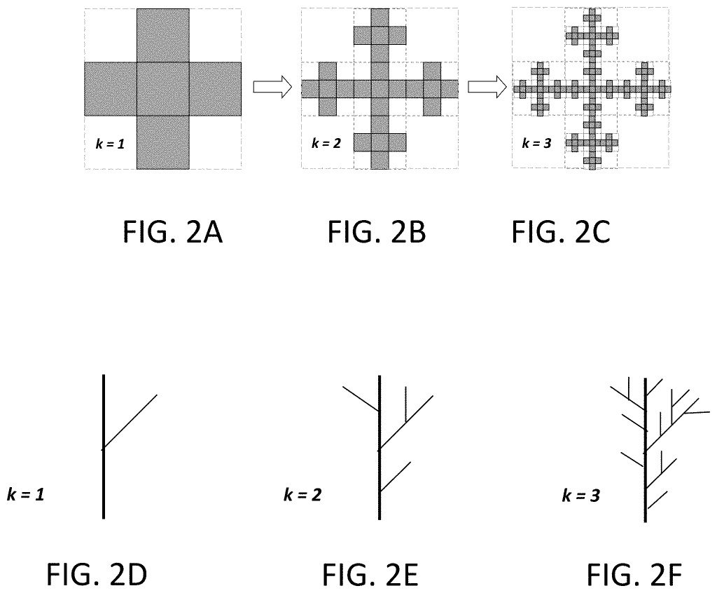

True fractals exhibit scale invariant properties, as illustrated by FIGS. 2A-2F. FIGS. 2A-2C depict the scale invariance of Vicsek fractals with (k=1, N=5, S=3), (k=2, N=25, S=9), and (k=b 3, N=125, S=27), respectively. Eq. 2 yields D=1.465 for this set of fractals. FIGS. 2D-2F depict the scale invariance of Mandelbrot-Vicsek deterministic fractal trees with (k=1, N=3, S=2). (k=2, N=9, S=4), and (k=3, N=27, S=8), respectively. Eq. 2 yields D=1.465 for this set of fractals.

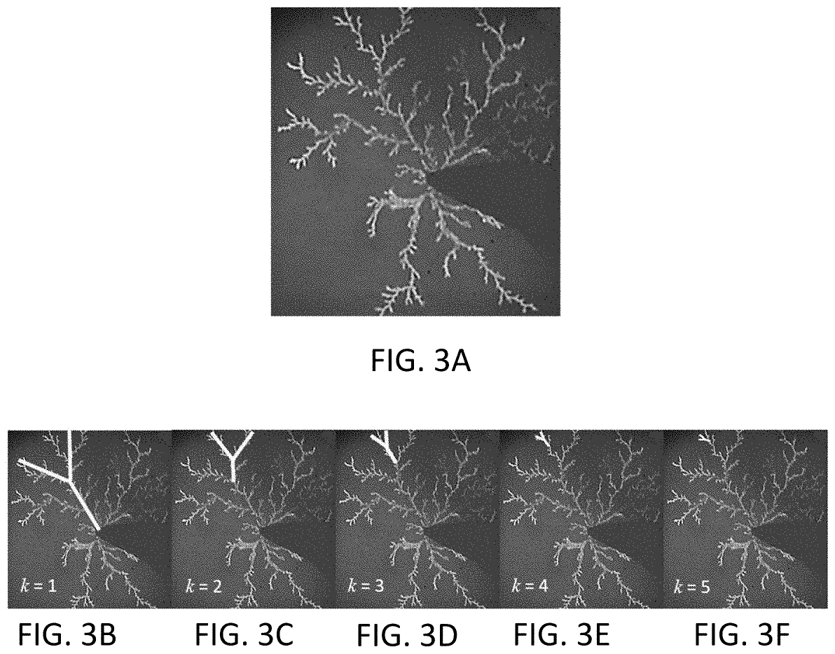

FIG. 3A is an image of a dendrite formed by electrochemical deposition. It is advantageous to determine the number of possible outcomes for the dendritic structure, as given by Eqs. 3 and 4:

Ω=iⁿ (3)

H=−Σᵢpᵢ log₂Pᵢ (4)

in which Ω is the number of outcomes, a is the number of symbols with i possible values, p is the probability of each value, and H is the number of bits per symbol.

FIGS. 3B-3F are images of dendrites with k=1-5, respectively, which illustrate the concept of entropy in dendrites as defined by the number of possible variations. The symbol superimposed on the images is a Y-shaped self-similar element that is repeated to form the entire dendrite. The number of variations Iₖ is given by Eq. 5:

Iₖ=(Πⱼ₌₁^{p})^{M}^{^{D}} (5)

in which D is the fractal dimension, M is the magnification factor given by (Sₖ/Sₗ), P is measured parameters, Rⱼ are readable states, and k is the generation/prefractal. The term M^{D} corresponds to the number of symbols.

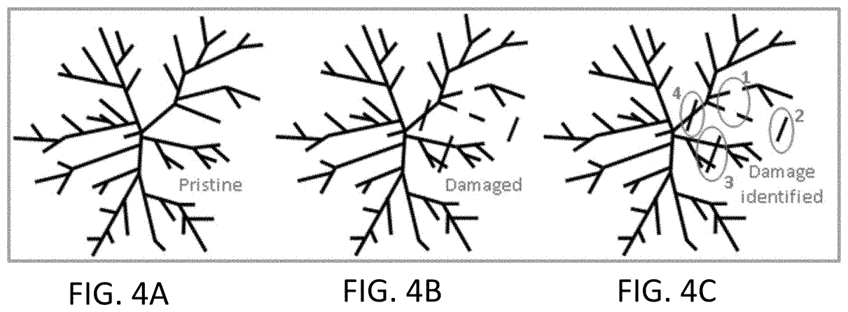

Fractal constructs have a small amount of structural information—each pattern is recognizable by the limited set of rules which dictate its formation. This rule-based predictability provides an advantage when dendrites are used as identifiers: errors in the pattern can be identified when the global or local rules have been violated. The rules include: no crossing branches; no backward or retrograde branching; no gaps or dismembered branches; the same fractal dimension everywhere plus radial or axial symmetry. FIG. 4A depicts a pristine dendrite with no errors. FIG. 4B depicts a damaged dendrite with structural errors. FIG. 4C depicts the identification of errors in the damaged dendrite through the violation of the given set of rules. This is an example of the use of known (zero entropy) functions to provide structure in arbitrary data for error correction.

Growing a dendrite by electrodeposition at relatively low field yields a physically unclonable function (PUF) with very high entropy. PUFs can be used as security primitives to provide hardware and item authentication and identification as well as secret key generation in cryptography. An advantageous characteristic of a PUF is the presence of noise. The function remains distinct and therefore the information it represents is well-preserved. Dendrites are advantageous in this respect, because their shape arises from a rule-based formation process which allows high information entropy in a pattern with low structural entropy.

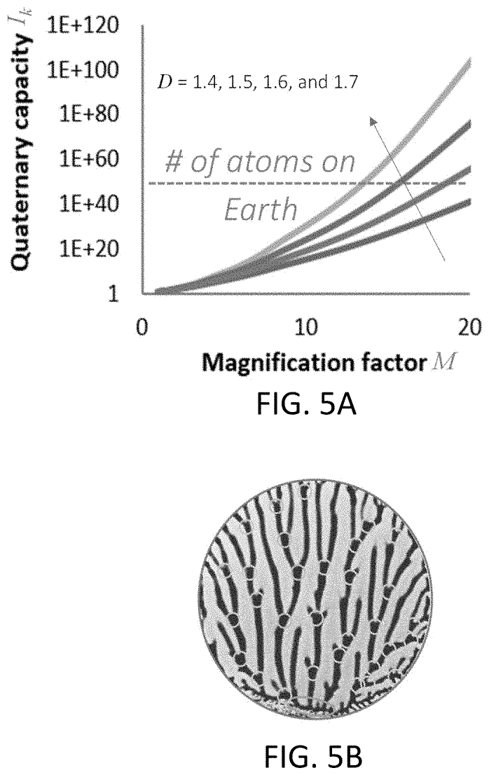

High entropy leads to a large number of possible variations. FIG. 5A is a plot of quatemary capacity (Iₖ) versus magnification factor (M) for D values of 1.4, 1.5, 1.6, and 1.7. For comparison, the dashed line in FIG. 5A corresponds to the number of atoms on planet earth. Eq. 5 can be used to calculate the number of variations Iₖ, for an example of a radial dendrite as shown in FIG. 5B. For a typical value of D=1.66, measuring 2 parameters (P) in every symbol and reading 2 states (R) in each, for a magnification factor (M) of 8 (4^{th} generation) the number of possible variations equals 1.84×10¹⁹.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method for assessing corruption of a dendritic structure, the method comprising:
obtaining an image of the dendritic structure, wherein the dendritic structure comprises branches extending away from a common point of the dendritic structure and defines a stochastic arrangement of the branches; and
assessing, based on the image, whether an arrangement of one or more of the branches violates a formation rule governing formation of the dendritic structure.

2. The method of claim 1, further comprising identifying the dendritic structure as corrupted if the arrangement of the one or more of the branches violates the formation rule governing formation of the dendritic structure.

3. The method of claim 1, further comprising identifying the dendritic structure as uncorrupted if the arrangement of the one or more branches obeys the formation rule governing formation of the dendritic structure.

4. The method of claim 1, wherein the formation rule is associated with a number of the branches, a spacing of the branches, a length of the branches, an angle between branches, or any combination thereof.

5. The method of claim 4, wherein the formation role is a power law rule associated with the number of the branches.

6. The method of claim 5, wherein the power law rule governs a number of branching points in each k^{th} order, wherein each k^{th} order has n^{k} branches, where n is an integer.

7. The method of claim 4, wherein a region of the dendritic structure comprises one or more self-similar features, and the formation rule is associated with a fractal dimension the region.

8. The method of claim 7, wherein one of the one or more self-similar features is a Y-shaped bifurcation comprising two of the branches extending from a trunk, and a length of the trunk and of each of the two branches is within ±30% of one-half of a total length of the dendritic structure.

9. The method of claim 7, wherein the fractal dimension is log x/log y, wherein x is the number of branches in each region and y is a scaling factor of a length of the branches.

10. The method of claim 1, wherein the formation rule is associated with the presence or absence of crossings of the one or more of the branches with another branch.

11. The method of claim 1, wherein the presence of a crossing of one or more of the branches with another branch is indicative of a corrupted dendritic structure.

12. The method of claim 1, wherein the formation rule is associated with the presence or absence of a discontinuity in the one or more of the branches.

13. The method of claim 1, wherein the presence of a discontinuity in the one or more of the branches is indicative of a corrupted dendritic structure.

14. The method of claim 1, wherein one of the one or more branches is a re-entrant branch, and the presence of the re-entrant branch is indicative of a corrupted dendritic structure.

15. The method of claim 2, further comprising, after identifying the dendritic structure as corrupted, modifying the image to yield a modified image, wherein the arrangement of the one or more of the branches in the modified image conforms to the formation rule.

16. The method of claim 15, wherein modifying the image comprises interpolating between a discontinuity in a feature of the dendritic structure or extrapolating from a feature of the dendritic structure.

17. The method of claim 15, wherein modifying the image comprises removing a feature from the image.

18. The method of claim 15, wherein modifying the image comprises modifying one or more pixels in the image.

19. The method of claim 1, wherein the formation rule is associated with a symmetry of the dendritic structure.

20. The method of claim 19, wherein a lack of reflection or rotation symmetry of the dendritic structure is indicative of a corrupted dendritic structure.
